(19) United States
(12) Patent Application Publication
(10) Pub. No.: US 2019/0368244 A1
(43) Pub. Date: Dec. 5, 2019

(54) LOUDSPEAKER STRUCTURE WITH PUSH-LATCH COUPLING DESIGN

(71) Applicant: LONGINESTENO TECHNOLOGY COMPLEX CORPORATION, New Taipei City (TW)

(72) Inventor: Chao-Lang WANG, New Taipei City (TW)

(73) Assignee: LONGINESTENO TECHNOLOGY COMPLEX CORPORATION, New Taipei City (TW)

(21) Appl. No.: 16/043,446

(22) Filed: Jul. 24, 2018

(30) Foreign Application Priority Data
Jun. 5, 2018 (TW) 107119347

(51) Int. Cl. E05C 19/02; H04R 1/02; E05C 19/06; H04R 1/28

(52) U.S. Cl. CPC E05C 19/022; H04R 1/025; H04R 2201/02; H04R 1/2819; H04R 1/023; E05C 19/06

(57) ABSTRACT

A loudspeaker structure with a push-latch coupling design includes an enclosure unit, a speaker driver, a mesh cover, and a push latch device. The push latch device includes a female latch portion and a male latch portion. The male latch portion is fixed on the inner side, and adjacent to the periphery, of the mesh cover and has a latching head. The female latch portion is fixed on, and adjacent to a through hole in, the front-panel frame of the enclosure unit and includes a locking mechanism. Once the latching head is inserted in the female latch portion, the locking mechanism enters a locking state, in which the mesh cover is locked to the enclosure unit and covers the speaker driver. A gentle press on the mesh cover can change the locking state into a release state to enable automatic separation between the mesh cover and the enclosure unit.

### FIELD OF THE INVENTION

The present invention relates to a loudspeaker structure and more particularly to one with a push-latch coupling design that includes at least one push latch device mounted between the enclosure unit (e.g., an open-baffle enclosure, a sealed enclosure, a bass reflex enclosure, a bandpass enclosure, or a passive-radiator enclosure) and the at least one mesh cover of a loudspeaker so that the mesh cover can he easily, rapidly, and securely positioned at and locked to a through hole of the enclosure unit without the assistance of an additional tool (e.g., a screwdriver or wrench) and thus cover the speaker driver in the through hole to effectively prevent dust and dirt from attaching to and hence degrading the driver diaphragm corresponding to the through hole or to effectively prevent an external pointed object from contacting and hence damaging the driver diaphragm, wherein the mesh cover can be detached from the through hole of the enclosure unit without using an additional tool too, simply by pressing the mesh cover gently with a finger to disengage the female and male latch portions of the push latch device to enable automatic separation between the mesh cover and the enclosure unit.

### BACKGROUND OF THE INVENTION

Over the last two decades, multimedia products with outstanding audiovisual effects have improved continuously, thanks to the rapid development of industrial technologies. These improvements not only have satisfied people's demand for a diversity of audiovisual effects and enjoyment to a great extent, but helped nowadays by the online digital audiovisual services provided by many music and video platforms on the Internet, have also made it possible to listen to high-quality digital music and watch high-resolution digital video programs over the Internet, thereby reducing, if not eliminating, the need to buy optical discs. When earphones are used to listen to music or the audio contents of video programs, however, the users' ears must feel the discomfort caused by persistent compression by the earphones. Moreover, one who is listening to music or the audio contents of a video program through earphones cannot change their body posture arbitrarily or substantially, let alone engage in physical exercise involving big movements, or the earphones may fall off. Most people, therefore, prefer listening to music or the audio contents of video programs through loudspeakers, whose sound quality is generally far better than that of earphones, and which also allow their users to savor their affecting sound effects in a more relaxed manner than earphones.

Conventional loudspeakers (or speakers for short) are mounted or installed in many different ways, depending on their fields of application, requirements, and structural designs, and can therefore be categorized as baffle speakers, in-ceiling speakers (as shown in FIG. 1), in-wall speakers, or standing speakers (as shown in FIG. 2), among others. Regardless of its category, a speaker M10 essentially includes an enclosure unit M11, at least one speaker driver (or driver for short) M12, and a mesh cover M13. The enclosure unit M11 may be a hollow box or a plate (i.e., a baffle) as appropriate to its category. To facilitate description, the following explanation reference to FIG. 1 and FIG. 2 is directed to an enclosure unit M11 formed as a hollow box. The enclosure unit M11 is provided therein with a receiving space M110 and has a front end formed with at least one through hole M111 in communication with the receiving space M110, As shown in FIG. 2, each driver M12 is fixed at the corresponding through hole M111 and has a diaphragm M120, and the configuration and specifications of the mesh cover M13 match those of the front-panel frame M112 so that the mesh cover M13 can be fixed on the enclosure unit M11 at a position corresponding to the front-panel frame M112 to cover the drivers M12. The mesh openings of the mesh cover M13 are sized to allow only the sound generated by the drivers M12 to propagate outward through the mesh cover M13. The mesh cover M13, therefore, can effectively prevent dust and dirt from attaching to and consequently degrading the diaphragm M120 of each drive M120, or protect the diaphragms M120 from contact with, and hence damage by, an external pointed object.

Generally, referring to FIG. 1, the mesh cover M13 is fixed to the enclosure unit M11 in one of the following ways. The first way is to match the inner diameter of a peripheral section of the enclosure unit M11 that is adjacent to the front-panel frame M112 to the outer diameter of the mesh cover M13 so that the inner periphery of the aforesaid peripheral section of the enclosure unit M11 can engage tightly with the outer periphery of the mesh cover M13. The second way is to provide the inner periphery of the front-panel frame M112 of the enclosure unit M11 with ribs and make the mesh cover M13 out of an elastic metal so that the outer periphery of the mesh cover M13 can be elastically deformed by the ribs and thus fit in the front-panel frame M112 of the enclosure unit M11. As the front-panel frame M112 of such an enclosure unit M11 typically has a fixed inner diameter corresponding to a fixed shape, the matching mesh cover M13 is generally a metal mesh cover with a spray-coated surface.

Another type of spray-coated metal mesh cover M13 is designed for use with magnets, or more particularly with an enclosure unit M11 provided with a plurality of strong magnets (not shown) at the back of an outer peripheral section of the enclosure unit M11 that is adjacent to the front-panel frame M112. The metal mesh cover M13, therefore, can be securely attached to the outer peripheral section of the enclosure unit M11 by the strong magnetic attraction of the magnets in order to cover the driver M12. Referring hack to FIG. 2, the enclosure unit M11 of a standing speaker is generally made of wood, with a plurality of (e.g., four as shown in FIG. 2) female fasteners M20 and a corresponding number of male fasteners M21 provided between the enclosure unit M11 and the mesh cover M13, wherein the fasteners are usually made of a plasticized material. Once the corresponding female and male fasteners are engaged with each other, the mesh cover M13 is fixed on the front-panel frame M112 of the enclosure unit M11. Generally, the mesh cover M13 of such a standing speaker M10 is made by covering a wood frame (sometimes a plastic frame) with fabric. In some other standing speakers M10, the mesh cover M13 is directly locked to the front-panel frame M112 of the enclosure unit M11 with a plurality of screws (not shown). To detach the mesh cover M13 of such a standing speaker M10, the screws must be sequentially removed with a hand tool (e.g., a screwdriver or wrench) first, or the mesh cover M13 cannot be detached from the enclosure unit M11. Obviously, the installation and removal of this type of mesh covers M13 are more complicated, labor-intensive, and time-consuming than those of the foregoing mesh covers, which are designed to be installed on and removed from their respective speakers M10 through mechanical engagement between corresponding elements.

While the methods by which to secure the mesh covers M13 of the various speakers M10 described above have prevailed for quite a long time, those methods leave much to be desired from the viewpoint of the inventor of the present invention, who has had ample practical experience and expertise in designing, developing, manufacturing, and selling all sorts of speakers. Take an in-ceiling or in-wall speaker M10 for example. Referring to FIG. 1, one who desires to remove the mesh cover M13 from the speaker M10 typically requires an additional hand tool (e.g., a screwdriver or wrench) for prying the metal mesh cover M13 away from or digging the metal mesh cover M13 out of the speaker M10. The prying or digging action, however, may damage the paint, if not the main body, of the metal mesh cover M13 or of the front-panel frame M112 of the enclosure unit M11 due to improper or careless force application or tool operation by the operator, and the appearance of the speaker M10 can be seriously compromised as a result. Besides, although the metal mesh cover M13 has the elasticity of its metal material and is designed to be elastically deformed by prying, digging, or force application in other forms in order to be fitted into or removed from the front-panel frame M112 of the enclosure unit M11 of the speaker M10, repeated detachment and reassembly will eventually cause elastic fatigue, and loss of elasticity, of the corresponding portions of the mesh cover M13 and of the enclosure unit M11 of the speaker M10, making it impossible to fit the metal mesh cover M13 securely in the front-panel frame M112 of the enclosure unit M11 of the speaker M10. Should that happen, the metal mesh cover M13 may easily fall off the enclosure unit M11 of the speaker M10 when the enclosure unit M11 is shaken.

With continued reference to FIG. 1, the spray-coated metal mesh cover M13 is attached to the front-panel frame M112 of the enclosure unit M11 of the speaker M10 by magnetic attraction and therefore will not experience elastic fatigue of its metal material or a loss of elasticity. However, if there are too few magnets or if the magnetism of the magnets is too weak to secure the metal mesh cover M13 in place, the mesh cover M13 still may fall off the front-panel frame M112 of the enclosure unit M11 of the speaker M10, drop to the ground, and end up damaged, when the enclosure unit M11 of the speaker M10 is shaken. Conversely, if a sufficient number of strong magnets are used to attach the metal mesh cover M13 securely to the front-panel frame M112 of the enclosure unit M11 of the speaker M10, detaching the metal mesh cover M13 will nevertheless require the exertion of a considerable amount of force, or the metal mesh cover M13 simply cannot be pried or dug out of the enclosure unit M11. Moreover, the large number of strong magnets add to the weight and production cost of the speaker M10 and go against the current trend of product design toward “light weight and compactness”.

Furthermore, as stated above with reference to FIG, 2, the conventional wood enclosure unit M11 of a standing speaker M10 typically couples with a fabric mesh cover M13 through mutual engagement between the plastic female fasteners M20 and male fasteners M21. As a result, one who desires to detach the fabric mesh cover M13 from the conventional wood enclosure unit M11 must apply a relatively large force to the fabric mesh cover M13 through a finger or tool in order to pull or pry the wood (or plastic) frame of the fabric mesh cover M13 away from the enclosure unit M11 of the standing speaker M10 using the finger or tool. As this detaching method involves pulling or prying, improper or careless force application by the operator often results in a painful or sprained finger due to overexertion, and the fabric of the mesh cover M13 may be punctured by reckless use of the tool. As to those standing speakers M10 whose mesh cover M13 is directly locked to the enclosure unit M11 with screws, the mesh cover M13 cannot be detached from the enclosure unit M11 without the laborious and inconvenient process of removing the screws one after another with an additional hand tool (e.g., a screwdriver or wrench) in advance.

The issue to be addressed by the present invention is to design a speaker structure in which the mesh cover can be easily and rapidly secured to and detached from the enclosure unit without using an additional hand tool such as a screwdriver or wrench.

### BRIEF SUMMARY OF THE INVENTION

In view of the fact that the enclosure units and mesh covers of various conventional speakers are coupled together in ways that cause the aforesaid problems and drawbacks, the inventor of the present invention incorporated years of practical experience and expertise in designing, developing, manufacturing, and selling all sorts of speakers into extensive research and repeated tests and finally succeeded in creating a speaker structure that features a push-latch coupling design. The invention is intended to overcome the foregoing problems and drawbacks at once so that the connection and disconnection between the enclosure unit and the mesh cover of a speaker is made easier, faster, and more convenient. The invention not only allows the mesh cover of a speaker to be attached to and detached from the enclosure unit without the assistance of an additional hand tool, but also eliminates the need to pry open the mesh cover forcibly with a finger. Thus, the operator's fingers are ensured against pain and sprain associated with improper or careless force application, and the corresponding portions of the mesh cover and of the front-panel frame of the enclosure unit are kept from damage of them spray coating, puncture in the mesh, and elastic fatigue of their metal material.

One objective of the present invention is to provide a speaker structure having a push-latch coupling design, wherein the speaker structure includes an enclosure unit, at least one speaker driver (or driver for short), at least one mesh cover, and at least one push latch device. The enclosure unit is a hollow housing provided therein with a receiving space. The front side of the enclosure unit is provided with at least one through hole in communication with the receiving space. The driver is fixed at the through hole of the enclosure unit and includes a diaphragm fixed on the driver. The mesh cover matches a front-panel frame of the enclosure unit in configuration and specifications in order to cover the driver. The mesh openings of the mesh cover are so sized that not only can the sound generated by the driver propagate outward through the mesh cover, but also the diaphragm of the driver is effectively protected from degradation that may otherwise result from the dust or dirt attached to the diaphragm, or is effectively sheltered from external pointed objects that may damage the diaphragm when in contact therewith. The push latch device includes a female latch portion and a male latch portion. The male latch portion is fixed on the inner side of the mesh cover at a position adjacent to the periphery of the mesh cover and is protrudingly provided with a latching head. The female latch portion is fixed between the outer periphery of the front-panel frame of the enclosure unit and the through hole of the enclosure unit, corresponds in position to the male latch portion, and is provided therein with a locking mechanism. When it is desired to mount the mesh cover on the enclosure unit, no additional hand tools are required. A user only has to bring the latching head of the male latch portion into alignment with the female latch portion and press the mesh cover gently, and the latching head of the male latch portion will be inserted into the female latch portion and thereby push, or slide the sliding block of the locking mechanism. Once slid to a predetermined depth in the female latch portion, the sliding block is stopped from sliding and enters the locking state, in which the latching head of the male latch portion is securely latched and gripped by the two hooks that extend from the front end, and generally along the longitudinal centerline, of the sliding block in two lateral directions of the longitudinal centerline respectively. As a result, the female latch portion and the male latch portion are coupled together, and the mesh cover is firmly locked to and positioned on the front-panel frame of the enclosure unit and covers the driver on the enclosure unit. When it is desired to detach the mesh cover from the enclosure unit, no additional hand tools are required, either. The user only has to press the mesh cover gently with a finger such that the latching head of the male latch portion pushes, or slides, the sliding block to the predetermined depth in the female latch portion, and the sliding block will be slid outward of the female latch portion, thereby releasing the latching head of the male latch portion from the two hooks on the front end of the sliding block, allowing the female latch portion and the male latch portion to disengage from each other and the mesh cover to separate from the enclosure unit automatically.

Another objective of the present invention is to further provide a pivotal connection element connected between the mesh cover and the enclosure unit. The pivotal connection element is fixed to the mesh cover at one end and is fixed in the front-panel frame of the enclosure unit at the opposite end, thereby keeping the mesh cover pivotally connected to the enclosure unit, preventing the mesh cover from falling heavily to the ground, and hence from being damaged, when the mesh cover separates from the front-panel frame of the enclosure unit automatically.

Still another objective of the present invention is to further provide a protective cable connected between the mesh cover and the enclosure unit. The protective cable is fixed to the mesh cover at one end and is fixed at the opposite end to the enclosure unit at a position between the outer periphery of the front-panel frame and the through hole, thereby keeping the mesh cover connected to the enclosure unit, preventing the mesh cover from falling heavily to the ground, and hence from being damaged, when the mesh cover separates from the front-panel frame of the enclosure unit automatically.

### BRIEF DESCRIPTION OF THE SEVERAL VIEWS OF THE DRAWINGS

The objectives and technical features of the present invention and the intended effects of the technical features can be better understood by referring to the following detailed description in conjunction with the accompanying drawings, in which:

FIG. 1 is a perspective view of a conventional in-ceiling speaker;

FIG. 2 is an exploded perspective view of a conventional standing speaker;

FIG. 3 is an exploded and partially sectional view of the speaker structure according to a preferred embodiment of the present invention;

FIG. 4 is a sectional view showing a push latch device in the preferred embodiment in FIG. 3 in the unlocked and separated state;

FIG. 5 is similar to FIG. 4 except that the push latch device is in the locked and coupled state;

FIG. 6 is a partially sectional view of the speaker structure according to another preferred embodiment of the invention;

FIG. 7 is a partial perspective view of the speaker structure according to still another preferred embodiment of the invention;

FIG, 8 is an exploded perspective view of the push latch device according to a preferred embodiment of the invention;

FIG, 9 shows the top-inner-wall guide groove and the guide post of the female latch portion of the push latch device in FIG. 8 in their initial state;

FIG, 10 shows the top-inner-wall guide groove and the guide post in FIG. 9 in the locked state and the unlocked state; and

FIG. 11 is a partial perspective view of the speaker structure according to yet another preferred embodiment of the invention, showing in particular the push latch device coupled to the supporting frame.

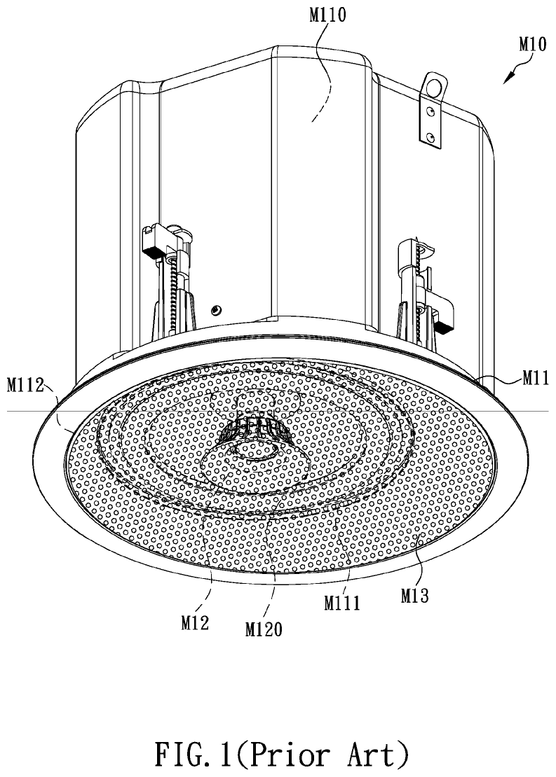

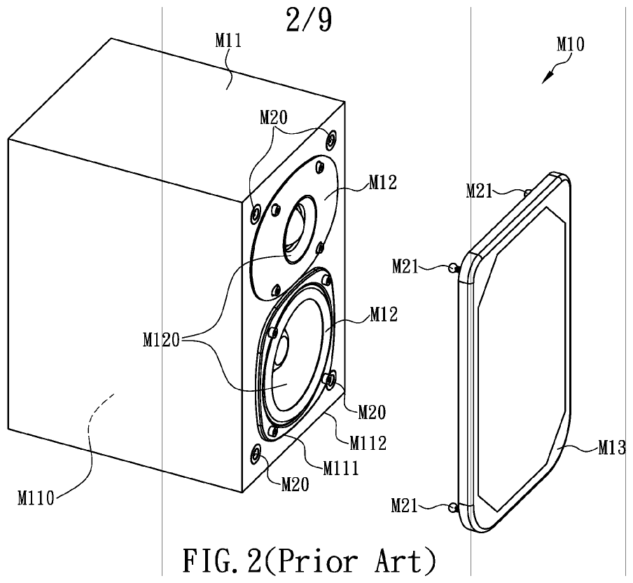

### DETAILED DESCRIPTION OF THE INVENTION

To overcome the aforementioned problems and drawbacks of the different methods for securing the mesh covers of various conventional speakers to their respective enclosure units, the inventor of the present invention came up with the idea of employing the “push latch device” commonly used in the cupboards on the market to allow a door of a cupboard to be rapidly latched to the cupboard frame. Such a “push latch device” includes a male latch portion and a female latch portion and works on the mechanical principle that the latch portions can be unlocked and separated from each other, as well as latched and coupled together, by pushing the latch portions against each other. According to the present invention, the female latch portion is incorporated into the enclosure unit of a speaker while the male latch portion is incorporated into the mesh cover of the speaker (or the male latch portion is incorporated into the enclosure unit while the female latch portion is incorporated into the mesh cover), the goal being to apply the “push latch device” to the interface between the enclosure unit and the mesh cover of any of the foregoing conventional speakers so that the mesh cover can be attached to and detached from the enclosure unit with greater ease and more rapidly, without having to use any hand tool or push or pry the mesh cover forcibly. Thanks to the “push latch device”, one who desires to latch and thereby couple a mesh cover to an enclosure unit or unlock and thereby separate the mesh cover from the enclosure can complete the desired operation simply by holding the mesh cover and pressing the mesh cover gently toward the enclosure unit.

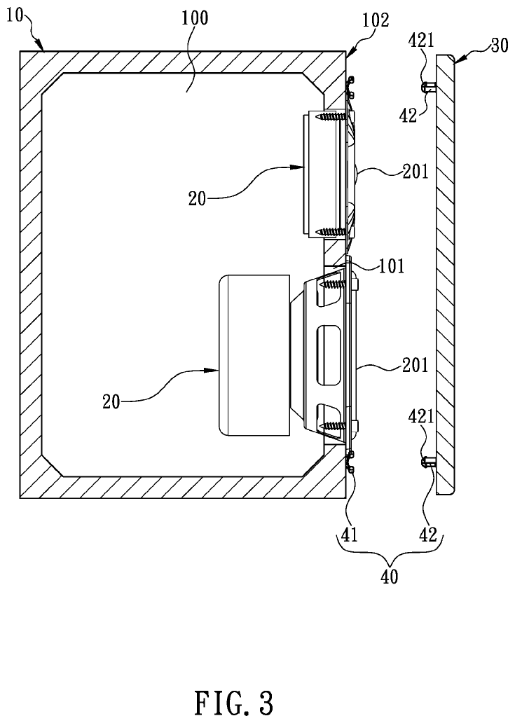

To shed more light on the technical concept stated above, a detailed description of the speaker structure with a push-latch coupling design according to the most preferred embodiment of the present invention is given below with reference to FIG. 3. The speaker structure includes an enclosure unit 10, at least one speaker driver (or driver for short) 20, at least one mesh cover 30, and at least one push latch device 40. It should be pointed out that the enclosure unit 10 in the invention may be, for example, an open-baffle enclosure, a sealed enclosure, a bass reflex enclosure, a bandpass enclosure, or a passive-radiator enclosure; that is to say, the enclosure unit 10 may be formed as a hollow box or a plate. In the most preferred embodiment, the enclosure unit 10 is a hollow box by way of example. The enclosure unit 10 is provided therein with a receiving space 100 and includes a front-panel frame 102, which forms the front side of the enclosure unit 10. The front-panel frame 102 is provided at least one through hole 101 in communication with the receiving space 100. The drivers 20 are respectively fixed at the through holes 101 of the enclosure unit 10 such that the diaphragm 201 on each driver 20 is exposed. The mesh cover 30 matches the front-panel frame 102 in configuration and specifications the area of the mesh cover 30 may be equal to or larger than that of the mounting frame of the drivers 20, i.e., the front-panel frame 102) in order to cover the drivers 20. The mesh openings of the mesh cover 30 are sized to allow the sound generated by the drivers 20 to propagate outward through the mesh cover 30. The size of the mesh openings is also effective in preventing dust and dirt from attaching to, and thus degrading, the diaphragms 201 or in protecting the diaphragms 201 from contact with, and hence damage by, an external pointed object.

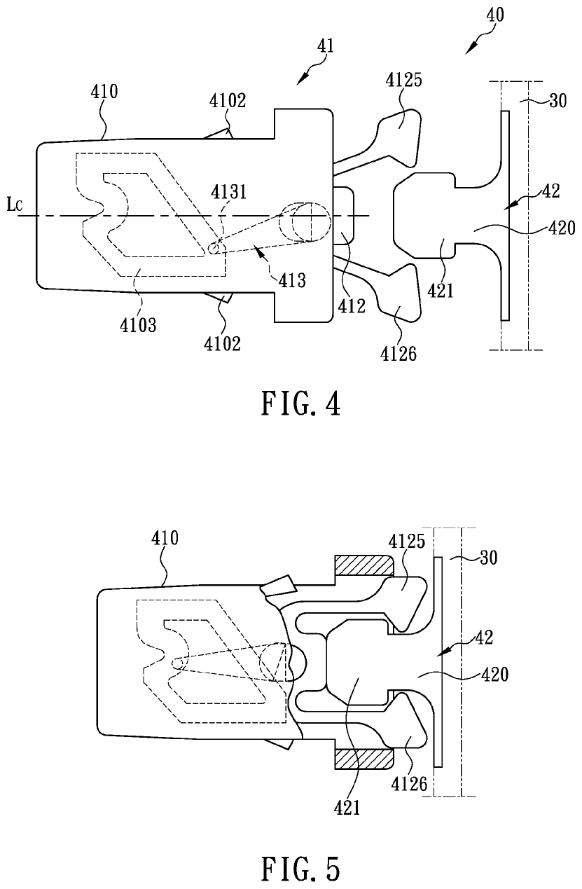

With continued reference to FIG. 3, each push latch device 40 includes a female latch portion 41 and a male latch portion 42. The male latch portions 42 are fixed on the inner side of the mesh cover 30 at positions adjacent to the periphery of the mesh cover 30, and each male latch portion 42 is protrudingly provided with a latching head. 421. The female latch portions 41 are fixed on a peripheral section of the enclosure unit 10 that is adjacent to the front-panel frame 102. The female latch portions 41 correspond in position to the male latch portions 42 respectively. In addition, each female latch portion 41 is provided therein with a locking mechanism. Thus, the mesh cover 30 can be mounted on the enclosure unit 10 without using any additional hand tool. More specifically, referring to FIG. 4, the mounting process includes holding or supporting the mesh cover 30 with one or two hands, aligning the latching head 421 of each male latch portion 42 with the corresponding female latch portion 41, inserting the latching head 421 of each male latch portion 42 into the corresponding female latch portion 41., and then pressing the mesh cover 30 gently toward the enclosure unit 10 so that the latching head 421 of each male latch portion 42 pushes, or slides, the sliding block 412 of the corresponding locking mechanism to a predetermined depth in the corresponding female latch portion 41, as shown in FIG. 5. Consequently, each sliding block 412 is stopped from sliding and enters and stays in the locking state, in which each latching head 421 is securely latched and gripped by the two hooks 4125 and 4126 extending from the front end, and generally along the longitudinal centerline Lc (indicated by the horizontal dashed line in FIG. 4), of the corresponding sliding block 412 in two lateral directions of the longitudinal centerline Lc respectively. And because of that, each female latch portion 41 and the corresponding male latch portion 42 are latched and coupled together, and the mesh cover 30 is firmly locked to and positioned on the front-panel frame 102 of the enclosure unit 10 and covers the drivers 20 on the enclosure unit 10. When it is desired to detach the mesh cover 30 from the enclosure unit 10, no additional hand tool is required, either. More specifically, referring to FIG. 5, the detaching process includes no other step than pressing the mesh cover 30 gently toward the enclosure unit 10 so that the latching head 421 of each male latch portion 42 pushes, or slides, the corresponding sliding block 412 to the predetermined depth in the corresponding female latch portion 41 again. Each sliding block 412 will then be slid outward of the corresponding female latch portion 41 to release the corresponding latching head 421 from the two hooks 4125 and 4126 at the front end of the sliding block 412, as shown in FIG. 4. Thus, each female latch portion 41 and the corresponding male latch portion 42 are unlocked and separated from each other, allowing the mesh cover 30 to separate from the enclosure unit 10 automatically.

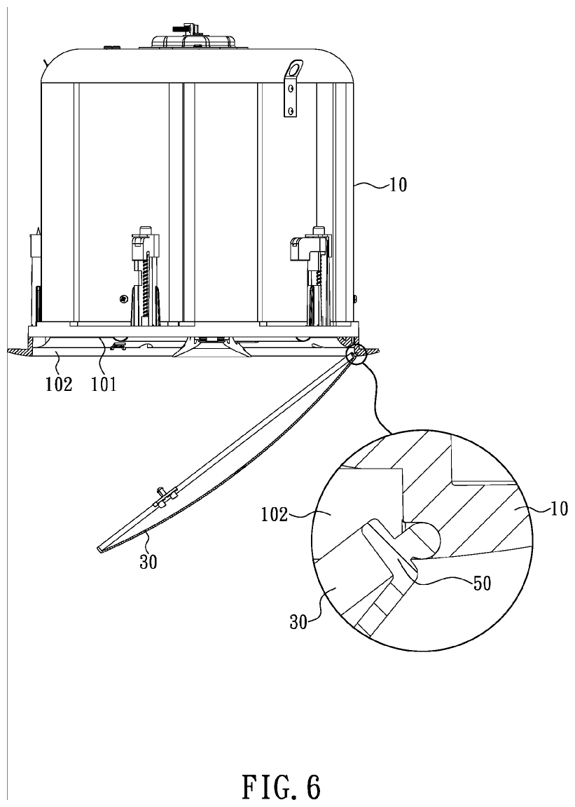

To protect the mesh cover 30 from damage that may otherwise result from a heavy fall to the ground when the mesh cover 30 separates from the enclosure unit 10 automatically, another preferred embodiment of the present invention further includes a pivotal connection element 50 connected between the mesh cover 30 and the enclosure unit 10 as shown in FIG. 6. The pivotal connection element 50 has one end fixed to the mesh cover 30 and the opposite end fixed (or pivotally connected) in the front-panel frame 102 of the enclosure unit 10 such that the mesh cover 30 remains pivotally connected to the enclosure unit 10.

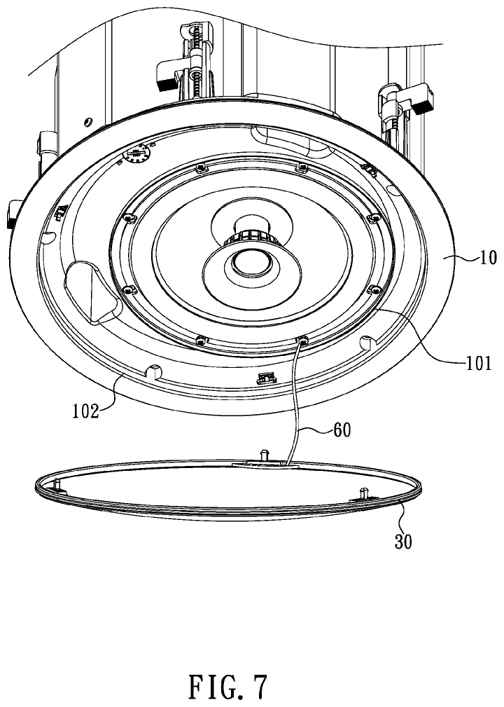

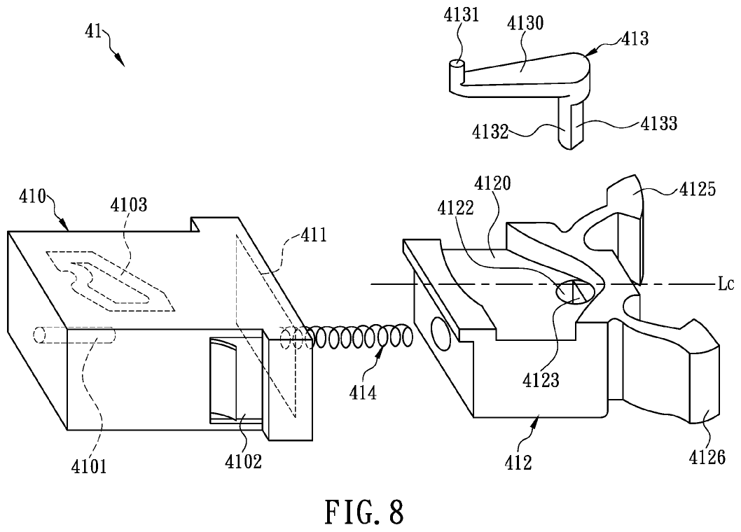

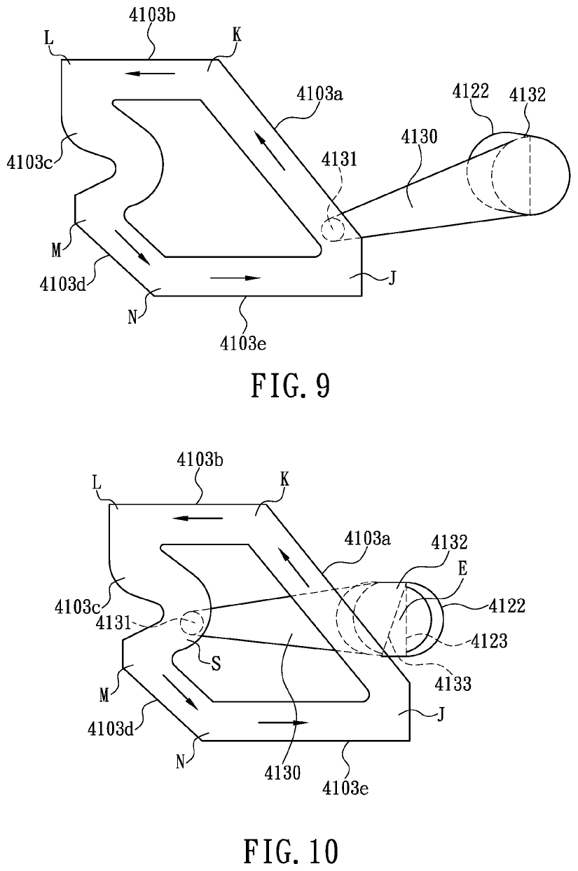

To protect the mesh cover 30 from damage that may otherwise result from a heavy fall to the ground when the mesh cover 30 separates from the enclosure unit 10 automatically, yet another preferred embodiment of the invention further includes a protective cable 60 connected between the mesh cover 30 and the enclosure unit 10 as shown in FIG. 7. The protective cable 60 has one end fixed on the mesh cover 30 and the opposite end fixed on the enclosure unit 10. In this embodiment, one end of the protective cable 60 lies between the outer periphery of the front-panel frame 102 and the through hole 101 (by way of example only), and the opposite end of the protective cable 60 is adjacent to the frame of the mesh cover 30 (by way of example only, too) to keep the mesh cover 30 connected to the enclosure unit 10.

As stated above, the push latch devices 40 used in the present invention have had wide application in various types of cupboards and are conventional elements for latching a door of a cupboard to the cupboard frame in response to a user pressing the door. The push latch device 40 shown in FIG. 4 and FIG. 5, therefore, is only a preferred embodiment. Now that the push latch devices 40 are well known in the art and have already been used extensively in cupboards, the push latch devices 40 described herein are not in themselves the core technique for which patent protection is claimed. The push latch devices 40 in other embodiments of the present invention may differ from the push latch devices 40 detailed below in terms of structure, components, and mechanism operation. The push latch devices 40 in the present invention can he any conventional ones, provided that each push latch device 40 includes a female latch portion 41 and a male latch portion 42; that one of the female latch portion 41 and the male latch portion 42 of each push latch device 40 is fixed on the mesh cover 30 and is protrudingly provided with a latching head 421; and that the other of the female latch portion 41 and the male latch portion 42 of each push latch device 40 is fixed on the enclosure unit 10, corresponds in position to the aforesaid latch portion of the same push latch device 40, and is provided therein with a locking mechanism so that the mesh cover 30 can be mounted or dismounted simply by pushing the female latch portion 41 and the male latch portion 42 of each push latch device 40 against each other to either latch and couple the corresponding female and male latch portions 41 and 42 together or unlock and separate the corresponding female and male latch portions 41 and 42 from each other.

To fully disclose the structural details of the push latch devices 40 in the present invention and the working principle of the mechanism involved, the push latch device 40 shown in FIG. 4 and FIG. 5 is described at length below as a preferred embodiment.

As shown in FIG. 4 and FIG. 5, the push latch device 40 includes a female latch portion 41 and a male latch portion 42. Referring to FIG. 8, the female latch portion 41 includes a housing 410, a sliding block 412, a guiding member 413, and a coil spring. 414. The coil spring 414 is made of metal while all the other components of the female latch portion 41 are made of plasticized materials. As shown in FIG. 8, the housing 410 is a hollow case and is provided with an opening 411 at one end. The housing 410 has an inner wall facing the opening 411 and protrudingly provided with a supporting member 4101. The supporting member 4101 extends along the longitudinal centerline Lc of the housing 410 (as indicated by the horizontal dashed line in FIG. 8). The longitudinal centerline of the housing 410 coincides with that of the sliding block 412. Two corresponding outer sidewalk of the housing 410 are each protrudingly provided with an engaging and positioning element 4102 so that the housing 410 can be engaged and positioned in the enclosure unit 10 (e.g., engaged with the front-panel frame 102 and positioned either on or in the front-panel frame 102) through the engaging and positioning elements 4102. The top inner wall of the housing 410 is concavely provided with a loop-shaped guide groove 4103. The sliding block 412 is accommodated in the housing 410 and can be slid inward and outward of the housing 410 with respect to the opening 411. The end of the sliding block 412 that corresponds to the opening 411 is protrudingly provided with two hooks 4125 and 4126. The two hooks 4125 and 4126 extend generally along the longitudinal centerline Lc of the sliding block 412 (as indicated by the horizontal dashed line in FIG. 8) in two lateral directions of the longitudinal centerline Lc respectively. The top side of the sliding block 412 is concavely provided with an accommodating space 4120. The guiding member 413 has one end downwardly protrudingly provided with a pivot shaft 4132, which allows the guiding member 413 to be pivotally provided on the top side of the sliding block 412. The opposite end (hereinafter referred to as the second end) of the guiding member 413 is upwardly protrudingly provided with a guide post 4131. The guide post 4131 is configured to be inserted in the loop-shaped guide groove 4103 in a movable manner, i.e., movable along the loop-shaped guide groove 4103. When the guide post 4131 is so moved, the body 4130 of the guiding member 413 is swayed in the accommodating space 4120 and thereby regulates the sliding movement of the sliding block 412. The coil spring 414 has one end mounted around the supporting member 4101 and pressed against the corresponding inner wall of the housing 410. The opposite end of the coil spring 414 is pressed against the sliding block 412 in order to push the sliding block 412 outward of the opening 411 of the housing 410 in directions deflected from the longitudinal centerline Lc of the sliding block 412.

In this preferred embodiment of the push latch device 40, referring to FIG. 9, the loop-shaped guide groove 4103 is a closed loop-shaped groove circuit formed jointly by a first oblique groove 4103a, a first longitudinal groove 4103b, a curved groove 4103c, a second oblique groove 4103d, and a second longitudinal groove 4103e. The loop-shaped guide groove 4103 has a uniform groove depth along the entire circuit. The first oblique groove 4103a is obliquely and concavely provided in the top inner wall of the housing 410 and extends from an end point J adjacent to the opening 411 to an end point K adjacent to a middle section of the housing 410. The first longitudinal groove 4103b is longitudinally and concavely provided in the top inner wall of the housing 410 and extends from the end point K to an end point L distant from the opening 411. The curved groove 4103c is curvedly and concavely provided in the top inner wall of the housing 410 and extends from the end point L to an end point M adjacent to the longitudinal centerline of the housing 410 such that a V-shaped groove is formed between the end points L and M, wherein the V-shaped groove has an apex pointing toward the opening 411 of the housing 410. With continued reference to FIG. 9, the second oblique groove 4103d is obliquely and concavely provided in the top inner wall of the housing 410 and extends from the end point M to an end point N adjacent to the middle section of the housing 410. The second oblique groove 4103d is substantially parallel to the first oblique groove 4103a. The second longitudinal groove 4103e is longitudinally and concavely provided in the top inner wall of the housing 410 and extends from the end point N to the end point J adjacent to the opening 411. The second longitudinal groove 4103e is substantially parallel to the first longitudinal groove 4103b.

Thus, the loop-shaped guide groove 4103 forms a closed loop-shaped guide groove circuit. The groove position corresponding to the end point J is defined as the circuit starting point of the loop-shaped guide groove 4103. The first oblique groove 4103a and the first longitudinal groove 4103b are defined as a return channel. The portion of the curved groove 4103c that corresponds to the apex of the V shape is a stopping position S for stopping the second end of the guiding member 413 (i.e., the end where the guide post 4131 is provided) from displacement.

Referring back to FIG. 8, the pivot shaft 4132, which protrudes downward from one end of the guiding member 413, is pivotally connected in a pivot hole 4122 in the top side of the sliding block 412 so that the body 4130 of the guiding member 413 can be swayed in the accommodating space 4120 about a center defined by the pivot shaft 4132. The pivot shaft 4132 is axially provided with a first abutting flat surface 4133 such that the cross section of the pivot shaft 4132 is generally semicircular. The first abutting flat surface 4133 and the length direction of the body 4130 of the guiding member 413 form an included angle of about 72 degrees. Once the pivot shaft 4132 is inserted in the pivot hole 4122 and the first abutting flat surface 4133 abuts against a second abutting flat surface 4123 in the pivot hole 4122, the hooks 4125 and 4126 on the sliding block 412 can be moved steadily inward of the opening 411 of the housing 410.

Referring back to FIG. 4 and FIG. 5, the male latch portion 42 is protrudingly provided with a latching post 420, and the free end of the latching post 420 is formed with the latching head 421. The latching head 421 is larger than the latching post 420 in configuration and matches the hooks 4125 and 4126 in order to be latched by and coupled with the hooks. Referring to FIG. 8 to FIG. 10, when the guiding member 413 of the female latch portion 41 is in the initial state (i.e., when the guide post 4131 has been displaced to a position in the loop-shaped guide groove 4103 that corresponds to the end point J), the guiding member 413 can be slid inward of the housing 410 against the elastic force applied by the coil spring 414 to the sliding block 412 and consequently to the guiding member 413 through the pivot hole 4122. During the process, the pivot shaft 4132 of the guiding member 413 is still being pushed in the pivot hole 4122 by the elastic force of the coil spring 414, so the guide post 4131 results in a torque that creates a gap E between the first abutting flat surface 4133 and the second abutting flat surface 4123, allowing a sidewall of the loop-shaped guide groove 4103 in the housing 410 to apply a transverse pressure on the guiding member 413, thereby moving the guide post 4131 along the return channel of the loop-shaped guide groove 4103 (i.e., the first oblique groove 4103a and the first longitudinal groove 4103b) and keeping the guide post 4131 in contact he sidewall of the loop-shaped guide groove 4103. Hence, referring to FIG. 4, FIG. 5, and FIG. 9, when a user presses the mesh cover 30 gently with a finger and thus pushes the sliding block 412 continuously via the latching head 421, the guide post 4131 will move throughout the length of the first oblique groove 4103a, then enter the first longitudinal groove 4103b, and after hitting the end point L, or the terminal point, of the first longitudinal groove 4103b, turn into the curved groove 4103c (see FIG, 10). If in this stage the force with which the user presses the mesh cover 30 (or with which the user pushes the sliding block 412 through the latching head 421) is removed, the guide post 4131 will be repelled by the curved groove 4103c and thus displaced to the stopping position S of the curved groove 4103c (which position corresponds to the apex of the V shape of the curved groove 4103c) because the sliding block 412 is constantly subjected to the elastic force applied by the coil spring 414 toward the opening 411 of the housing 410 and the pivot shaft 4132 is subjected to the torque tending to create the gap E. When the guide post 4131 reaches the stopping position S, referring to FIG. 8 and FIG. 10, the elastic force applied by the coil spring 414 to the sliding block 412 (i.e., toward the opening 411 of the housing 410) keeps the guide post 4131 pressed against a sidewall portion of the curved groove 4103c that corresponds to the stopping position S; as a result, the guide post 4131 is in a stopped state and cannot be moved any further. Now that the sliding block 412 in this state s held at a position deep in the housing 410, as shown in FIG. 5, the hooks 4125 and 4126 will stay firmly in the locking state,in which the latching head 421 is latched and gripped by the hooks 4125 and 4126 to couple the enclosure unit 10 and the mesh cover 30 securely together. When the user once again presses the mesh cover 30 gently with a finger and thus pushes the sliding block 412 continuously via the latching head 421, referring to FIG. 5 and FIG. 10, the guide post 4131 will move along the loop-shaped guide groove 4103 and eventually leave the curved groove 4103c. After that, the guide post 4131 will move throughout the length of the second oblique groove 4103d, then enter the second longitudinal groove 4103e, and after hitting the end point or the terminal point, of the second longitudinal groove 4103e, turn into the first oblique groove 4103a, thus arriving at the starting point of another cycle. By now, referring to FIG. 4, the outer end of the sliding block 412 (i.e., the end adjacent to the hooks 4125 and 4126) has already slid out of the housing 410 to keep the hooks 4125 and 4126 in the unlocking state, in which the hooks 4125 and 4126 have released the latching head 421 to enable automatic separation of the mesh cover 30 from the enclosure unit 10 so that the mesh cover 30 can be detached from the enclosure unit 10 with ease.

In addition, when the female latch portion 41 and the male latch portion 42 of the push latch device 40 are latched and coupled together, vibrations in the environment may cause the female latch portion 41 and the male latch portion 42 collide with each other and thus generate noise due to the gap between the two latch portions. To prevent such collision, the female latch portion 41 and the male latch portion 42 can be coated with a layer of soft padding in areas where the two latch portions are potentially in contact each other, or the mesh cover 30 and the enclosure unit 10 can be coated with a soft padding in areas where the mesh cover 30 and the enclosure unit 10 are potentially in contact each other. The soft padding may be made of an elastic plasticized material (e.g., ethylene-vinyl acetate (EVA), plastic, rubber, or foam) or a spring, and the thickness and size of the soft padding can be properly adjusted according to the gap between the female latch portion 41 and the male latch portion 42, the gap between the mesh cover 30 and the enclosure unit 10, the area of contact between the mesh cover 30 and the enclosure unit 10, and the magnitude of ambient vibrations, in order for the soft padding to effectively absorb the vibrations between the female latch portion 41 and the male latch portion 42 or between the mesh cover 30 and the enclosure unit 10 of the speaker, thereby preventing noise that may otherwise result from undesirable vibrations and interfere with the sound of the speaker. The latching post 420 may also be covered with rubber or be formed of a soft plastic material by injection molding to prevent noise that may otherwise be generated by coupling the latching post 420 to the sliding block 412. It is worth mentioning that the latching post 420 may be integrally formed with the frame of the mesh cover by injection molding, regardless of the material of the frame, or be a separate component connected to the frame of the mesh cover.

Other than the “hollow box-shaped” enclosure unit described above, the push latch devices in the present invention are equally applicable to a “plate-shaped” enclosure unit (i.e., a baffle), which is different from a “hollow box-shaped” enclosure unit in that a “plate-shaped” enclosure unit has a free open space at the back (i.e., on the rear side). A person skilled in the art who fully understands the technical contents disclosed herein should have no problem applying the foregoing embodiments to various types of enclosure units.

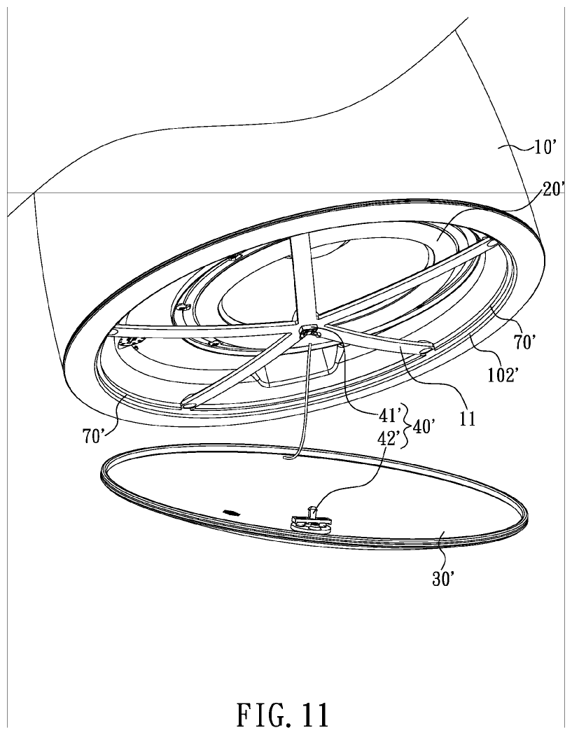

In another embodiment of the present invention, in which a single push latch device is provided by way of example, and which is illustrated in FIG. 11, the front side of the enclosure unit 10′ is provided with a through hole, and the driver 20′ is fixed to the enclosure unit 10′ at a position corresponding to the through hole (the through hole is not particularly indicated in the drawing because of the driver 20′ accommodated therein). In addition, the front side of the enclosure unit 10′ is protrudingly provided with at least one supporting frame 11. The supporting frame 11 is spaced apart from the driver 20′ and is provided with the female latch portion 41′, and the inner side of the mesh cover 30′ is provided with the male latch portion 42′. The female latch portion 41′ can couple with the male latch portion 42′ to form the push latch device 40′. The working principle of the push latch device 40′ is identical to that of the push latch device 40 and therefore will not be repeated. A user only has to mount the mesh cover 30′ on the enclosure unit 10′ by pressing the frame of the mesh cover 30′ against the soft padding 70′ bonded adhesively to the inner periphery of the front-panel frame 102′, and the female latch portion 41′ will couple with the male latch portion 42′ to position the mesh cover 30′ securely on the enclosure unit 10′ and thereby cover the driver 20′ with the mesh cover 30′. The user only has to press the mesh cover 30′ gently again, and the female latch portion 41′ will separate from the male latch portion 42′, allowing the mesh cover 30′ to be removed. It is worth mentioning that the female latch portion 41′ and the male latch portion 42′ may swap positions in other embodiments of the present invention.

While the invention herein disclosed has been described by means of specific embodiments, numerous modifications and variations could be made thereto by those skilled in the art without departing from the scope of the invention set forth in the claims.

What is claimed is:

1. A loudspeaker structure with a push-latch coupling design, comprising:
an enclosure unit formed as a hollow box or a plate, wherein the enclosure unit comprises a front-panel frame provided with at least one through hole;
at least one speaker driver fixed on the enclosure unit and corresponding to the through hole;
at least one mesh cover matching the front-panel frame in configuration and specifications so as to cover the speaker driver, wherein the mesh cover has mesh openings sized to not only allow sound generated by the speaker driver to propagate outward through the mesh cover, but also effectively prevent dust and dirt from attaching to and consequently degrading a diaphragm of the speaker driver or an external pointed object from contacting and consequently damaging the diaphragm; and
at least one push latch device comprising a female latch portion and a male latch portion, wherein the male latch portion is fixed on an inner side of the mesh cover and is protrudingly provided with a latching head; the female latch portion is fixed on the enclosure unit and corresponds in position to the male latch portion; when the latching head of the male latch portion is inserted in the female latch portion and has pushed a sliding block in the female latch portion to a predetermined depth in the female latch portion in a sliding manner, the sliding block is stopped from sliding such that the latching head is securely latched and gripped by two hooks extending from a front end, and generally along a longitudinal centerline, of the sliding block in two lateral directions of the longitudinal centerline of the sliding block respectively, thereby latching and coupling the female latch portion and the male latch portion together, allowing the mesh cover to be positioned securely on the enclosure unit and cover the speaker driver on the enclosure unit; and when the latching head of the male latch portion has, in response to a gentle press on the mesh cover, pushed the sliding block again to the predetermined depth in the female latch portion in the sliding manner, the sliding block is slid outward of the female latch portion such that the two hooks at the front end of the sliding block release the latching head, allowing the female latch portion and the male latch portion to disengage from each other and the mesh cover to separate from the enclosure unit automatically.

2. The loudspeaker structure of claim I, wherein the female latch portion comprises a housing, the sliding block, a guiding member, and a coil spring; the coil spring is made of metal while each of the housing, the sliding block, and the guiding member is made of a plasticized material; the housing is a hollow case and has an end formed with an opening; the housing has an inner wall facing the opening and protrudingly provided with a supporting member; the supporting member extends along a longitudinal centerline of the housing; the housing has two corresponding outer sidewalls each protrudingly provided with an engaging and positioning element in order for the housing to be engaged with, and positioned in, the front-panel frame of the enclosure unit through the engaging and positioning elements; the housing has a top inner wall concavely provided with a loop-shaped guide groove; the sliding block is accommodated in the housing and is slidable inward and outward of the housing with respect to the opening; the front end of the sliding block corresponds to the opening; the sliding block has a top side concavely provided with an accommodating space; the guiding member has an end downwardly protrudingly provided with a pivot shaft in order for the guiding member to be pivotally provided on the top side of the sliding block through the pivot shaft; the guiding member has an opposite end upwardly protrudingly provided with a guide post movably inserted in the loop-shaped guide groove; the guide post is movable along the loop-shaped guide groove in order for a body of the guiding member to sway in the accommodating space, thereby regulating a sliding movement of the sliding block; and the coil spring has an end mounted around the supporting member and pressed against the inner wall of the housing and has an opposite end pressed against the sliding block in order to push the sliding block outward of the opening of the housing in directions deflected from the longitudinal centerline of the sliding block.

3. The loudspeaker structure of claim I, wherein the female latch portion comprises a housing, and the housing has two corresponding outer sidewalls each protrudingly provided with an engaging and positioning element in order for the housing to be engaged with, and positioned on or in, the front-panel frame of the enclosure unit through the engaging and positioning elements.

4. The loudspeaker structure of claim 2, wherein the loop-shaped guide groove is a closed loop-shaped groove circuit formed jointly by a first oblique groove, a first longitudinal groove, a curved groove, a second oblique groove, and a second longitudinal groove; the loop-shaped guide groove has a uniform groove depth along the entire circuit; the first oblique groove is obliquely and concavely provided in the top inner wall of the housing and extends from an end point adjacent to the opening to a first end point adjacent to a middle section of the housing; the first longitudinal groove is longitudinally and concavely provided in the top inner wall of the housing and extends from the first end point adjacent to the middle section of the housing to an end point distant from the opening; the curved groove is curvedly and concavely provided in the top inner wall of the housing, extends from the end point distant from the opening to an end point adjacent to the longitudinal centerline of the housing, and forms a V-shaped groove with an apex pointing toward the opening of the housing; the second oblique groove is obliquely and concavely provided in the top inner wall of the housing, extends from the end point adjacent to the longitudinal centerline of the housing to a second end point adjacent to the middle section of the housing, and is substantially parallel to the first oblique groove; and the second longitudinal groove is longitudinally and concavely provided in the top inner wall of the housing, extends from the second end point adjacent to the middle section of the housing to the end point adjacent to the opening, and is substantially parallel to the first longitudinal groove.

5. The loudspeaker structure of claim 4, wherein the male latch portion is protrudingly provided with a latching post, the latching post has a free end formed with the latching head, and the latching head is larger than the latching post in configuration and matches the hooks in order to be latched by and coupled with the hooks.

6. The loudspeaker structure of claim 5, wherein the female latch portion and the male latch portion are coated with a layer of soft padding in areas where the female latch portion and the male latch portion are potentially in contact with each other, and the soft padding is made of an elastic plasticized material selected from the group consisting of ethylene-vinyl acetate (EVA), plastic, rubber, and foam.

7. The loudspeaker structure of claim 6, wherein the enclosure unit has a front side protrudingly provided with at least one supporting frame, and the supporting frame is spaced apart from the speaker driver and is provided with the female latch portion.

8. The loudspeaker structure of claim 6, further comprising a pivotal connection element connected between the mesh cover and the enclosure unit, wherein the pivotal connection element has an end fixed to the mesh cover and an opposite end fixed to or pivotally connected to the front-panel frame of the enclosure unit in order to keep the mesh cover pivotally connected to the enclosure unit and render the mesh cover rotatable with respect to the enclosure unit.

9. The loudspeaker structure of claim 6, further comprising a protective cable connected between the mesh cover and the enclosure unit, wherein the protective cable has an end fixed to the mesh cover and an opposite end fixed to the enclosure unit such that the protective cable stays connected to the mesh cover and the enclosure unit.

10. The loudspeaker structure of claim 7, further comprising a protective cable connected between the mesh cover and the supporting frame, wherein the protective cable has an end fixed to the mesh cover and an opposite end fixed to the supporting frame such that the protective cable stays connected to the mesh cover and the supporting frame.

11. A loudspeaker structure with a push-latch coupling design, comprising:
an enclosure unit formed as a hollow box or a plate, wherein the enclosure unit comprises a front-panel frame provided with at least one through hole;
at least one speaker driver fixed on the enclosure unit and corresponding to the through hole;
at least one mesh cover matching the front-panel frame in configuration and specifications so as to cover the speaker driver, wherein the mesh cover has mesh openings sized to not only allow sound generated by the speaker driver to propagate outward through the mesh cover, but also effectively prevent dust and dirt from attaching to and consequently degrading a diaphragm of the speaker driver or an external pointed object from contacting and consequently damaging the diaphragm; and
at least one push latch device comprising a female latch portion and a male latch portion, wherein the male latch portion is fixed on the enclosure unit and is protrudingly provided with a latching head; the female latch portion is fixed on an inner side of the mesh cover and corresponds in position to the male latch portion; when the latching head of the male latch portion is inserted in the female latch portion and has pushed a sliding block in the female latch portion to a predetermined depth in the female latch portion in a sliding manner, the sliding block is stopped from sliding such that the latching head is securely latched and gripped by two hooks extending from a front end, and generally along a longitudinal centerline, of the sliding block in two lateral directions of the longitudinal centerline of the sliding block respectively, thereby latching and coupling the female latch portion and the male latch portion together, allowing the mesh cover to be positioned securely on the enclosure unit and cover the speaker driver on the enclosure unit; and when the latching head of the male latch portion has, in response to a gentle press on the mesh cover, pushed the sliding block again to the predetermined depth in the female latch portion in the sliding manner, the sliding block is slid outward of the female latch portion such that the two hooks at the front end of the sliding block release the latching head, allowing the female latch portion and the male latch portion to disengage from each other and the mesh cover to separate from the enclosure unit automatically.

12. The loudspeaker structure of claim 11, wherein the female latch portion comprises a housing, the sliding block, a guiding member, and a coil spring; the coil spring is made of metal while each of the housing, the sliding block, and the guiding member is made of a plasticized material; the housing is a hollow case and has an end formed with an opening; the housing has an inner wall facing the opening and protrudingly provided with a supporting member; the supporting member extends along a longitudinal centerline of the housing; the housing has two corresponding outer sidewalls each protrudingly provided with an engaging and positioning element in order for the housing to be engaged with, and positioned in, the front-panel frame of the enclosure unit through the engaging and positioning elements; the housing has a top inner wall concavely provided with a loop-shaped guide groove; the sliding block is accommodated in the housing and is slidable inward and outward of the housing with respect to the opening; the front end of the sliding block corresponds to the opening; the sliding block has a top side concavely provided with an accommodating space; the guiding member has an end downwardly protrudingly provided with a pivot shaft in order for the guiding member to be pivotally provided on the top side of the sliding block through the pivot shaft; the guiding member has an opposite end upwardly protrudingly provided with a guide post movably inserted in the loop-shaped guide groove; the guide post is movable along the loop-shaped guide groove in order for a body of the guiding member to sway in the accommodating space, thereby regulating a sliding movement of the sliding block; and the coil spring has an end mounted around the supporting member and pressed against the inner wall of the housing and has an opposite end pressed against the sliding block in order to push the sliding block outward of the opening of the housing in directions deflected from the longitudinal centerline of the sliding block.

13. The loudspeaker structure of claim 11, wherein the female latch portion comprises a housing, and the housing has two corresponding outer sidewalls each protrudingly provided with an engaging and positioning element in order for the housing to be engaged with, and positioned on or in, the front-panel frame of the enclosure unit through the engaging and positioning elements.

14. The loudspeaker structure of claim 12, wherein the loop-shaped guide groove is a closed loop-shaped groove circuit formed jointly by a first oblique groove, a first longitudinal groove, a curved groove, a second oblique groove, and a second longitudinal groove; the loop-shaped guide groove has a uniform groove depth along the entire circuit; the first oblique groove is obliquely and concavely provided in the top inner wall of the housing and extends from an end point adjacent to the opening to a first end point adjacent to a middle section of the housing; the first longitudinal groove is longitudinally and concavely provided in the top inner wall of the housing and extends from the first end point adjacent to the middle section of the housing to an end point distant from the opening; the curved groove is curvedly and concavely provided in the top inner wall of the housing, extends from the end point distant from the opening to an end point adjacent to the longitudinal centerline of the housing, and forms a V-shaped groove with an apex pointing toward the opening of the housing; the second oblique groove is obliquely and concavely provided in the top inner wall of the housing, extends from the end point adjacent to the longitudinal centerline of the housing to a second end point adjacent to the middle section of the housing, and is substantially parallel to the first oblique groove; and the second longitudinal groove is longitudinally and concavely provided in the top inner wall of the housing, extends from the second end point adjacent to the middle section of the housing to the end point adjacent to the opening, and is substantially parallel to the first longitudinal groove.

15. The loudspeaker structure of claim 14, wherein the male latch portion is protrudingly provided with a latching post, the latching post has a free end formed with the latching head, and the latching head is larger than the latching post in configuration and matches the hooks in order to be latched by and coupled with the hooks.

16. The loudspeaker structure of claim 15, wherein the female latch portion and the male latch portion are coated with a layer of soft padding in areas where the female latch portion and the male latch portion are potentially in contact with each other, and the soft padding is made of an elastic plasticized material selected from the group consisting of ethylene-vinyl acetate (EVA), plastic, rubber, and foam.

17. The loudspeaker structure of claim 16, wherein the enclosure unit has a front side protrudingly provided with at least one supporting frame, and the supporting frame is spaced apart from the speaker driver and is provided with the male latch portion.

18. The loudspeaker structure of claim 16, further comprising a pivotal connection element connected between the mesh cover and the enclosure unit, wherein the pivotal connection element has an end fixed to the mesh cover and an opposite end fixed to or pivotally connected to the front-panel frame of the enclosure unit in order to keep the mesh cover pivotally connected to the enclosure unit and render the mesh cover rotatable with respect to the enclosure unit.

19. The loudspeaker structure of claim 16, further comprising a protective cable connected between the mesh cover and the enclosure unit, wherein the protective cable has an end fixed to the mesh cover and an opposite end fixed to the enclosure unit such that the protective cable stays connected to the mesh cover and the enclosure unit.

20. The loudspeaker structure of claim 17, further comprising a protective cable connected between the mesh cover and the supporting frame, wherein the protective cable has an end fixed to the mesh cover and an opposite end fixed to the supporting frame such that the protective cable stays connected to the mesh cover and the supporting frame.
